(19) United States
(12) Patent Application Publication
(10) Pub. No.: US 2025/0248343 A1
(43) Pub. Date: Aug. 7, 2025

(54) COLLAPSIBLE SOIL CONTAINER

(71) Applicant: Jesse Entz, Leduc (CA)

(72) Inventor: Jesse Entz, Leduc (CA)

(21) Appl. No.: 18/433,947

(22) Filed: Feb. 6, 2024

(51) Int. Cl. A01G 9/02

(52) U.S. Cl. CPC A01G 9/026

(57) ABSTRACT

A collapsible soil container that is configured to be moved from a collapsed position to a deployed position wherein in the deployed position the containment member of the present invention is operable to receive and retain soil therein. The present invention includes a frame wherein the frame has a first pair of leg members and a second pair of leg members located at opposing ends thereof. The frame includes a top support member that defines an upper perimeter and an opening of the frame in its deployed position. The top support member is operably coupled to the first pair of leg members and second pair of leg members at opposing ends thereof. A containment member, manufactured from burlap or other similar material, is operably coupled to the frame wherein the containment member is placed through the top support member and releasably coupled thereto.

### FIELD OF THE INVENTION

The present invention relates generally to soil containers, more specifically but not by way of limitation, a collapsible soil container that includes a frame wherein the frame is movable between a stored and deployed position and wherein the present invention further includes a flexible container configured to receive and retain soil therein.

### BACKGROUND

Over the last decade, the number of individuals that have begun to grow their own fruits and vegetables have tripled. Individuals have concerns about parameters such as but not limited to pesticides and genetically modified crops and as such the trend to grow produce has expanded exponentially. While single family homeowners typically have space to construct a garden, this is much more challenging for those individuals that do not have access to sufficient space to grow produce. Individuals that live in multifamily dwellings and other similar smaller properties will typically only have a small patio of balcony. Even single family homes may be limited on space where produce can be grown.

Most commercially available containers for growing plants is manufactured from rigid materials such as but not limited to clay or plastic. These containers come in various different sizes but the containers required to grow produce producing plants can be quite large. The size of these containers can present a problem as their footprint can intrude on smaller spaces. Conventional containers when not in use require a significant amount of storage. These conventional containers lack flexibility and cannot be stored with a reduced footprint. Furthermore, the rigid design provides one size only and the container cannot be adapted for alternate growing requirements.

Accordingly, there is a need for a soil container wherein the soil container is configured to be collapsible so as to improve the ability to store when not in use and wherein the present invention employs a containment member that can be provided in alternate sizes that is operably coupled to a frame.

### SUMMARY OF THE INVENTION

It is the object of the present invention to provide a soil container that is configured to receive soil for growing plants therein wherein the present invention includes a frame configured to receive and support a containment member.

Another object of the present invention is to provide a collapsible soil container that includes a stored position and a deployed position wherein the frame of the present invention includes a first pair of leg members and a second pair of leg members.

A further object of the present invention is to provide a soil container that is configured to receive soil for growing plants therein wherein the frame member includes a top support member that is rectangular in shape and operably coupled to the first pair of leg members and the second pair of leg members.

Yet a further object of the present invention is to provide a collapsible soil container that includes a stored position and a deployed position wherein the present invention includes a containment member that is operably coupled to the frame.

Still another object of the present invention is to provide a soil container that is configured to receive soil for growing plants therein wherein the containment member has an interior volume configured to receive and retain soil.

An additional object of the present invention is to provide a collapsible soil container that includes a stored position and a deployed position wherein the containment member is manufactured from a material such as but not limited to burlap.

Yet a further object of the present invention is to provide a soil container that is configured to receive soil for growing plants therein wherein the frame and containment member are provided in alternate sizes.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of the frame of the present invention in a collapsed position; and

FIG. 2 is a perspective view of the present invention; and

FIG. 3 is a perspective view of the frame of the present invention in a deployed position.

### DETAILED DESCRIPTION

Referring now to the drawings submitted herewith, wherein various elements depicted therein are not necessarily drawn to scale and wherein through the views and figures like elements are referenced with identical reference numerals, there is illustrated a collapsible soil container 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the collapsible soil container 100 includes a frame 10 wherein the frame 10 is manufactured from a durable lightweight material such as but not limited to plastic or aluminum. It should be understood within the scope of the present invention that the frame 10 could be provided in alternate sizes. Furthermore, while the frame 10 is illustrated herein as being rectangular in shape, it is contemplated within the scope of the present invention that the frame 10 could be provided in alternate shapes.

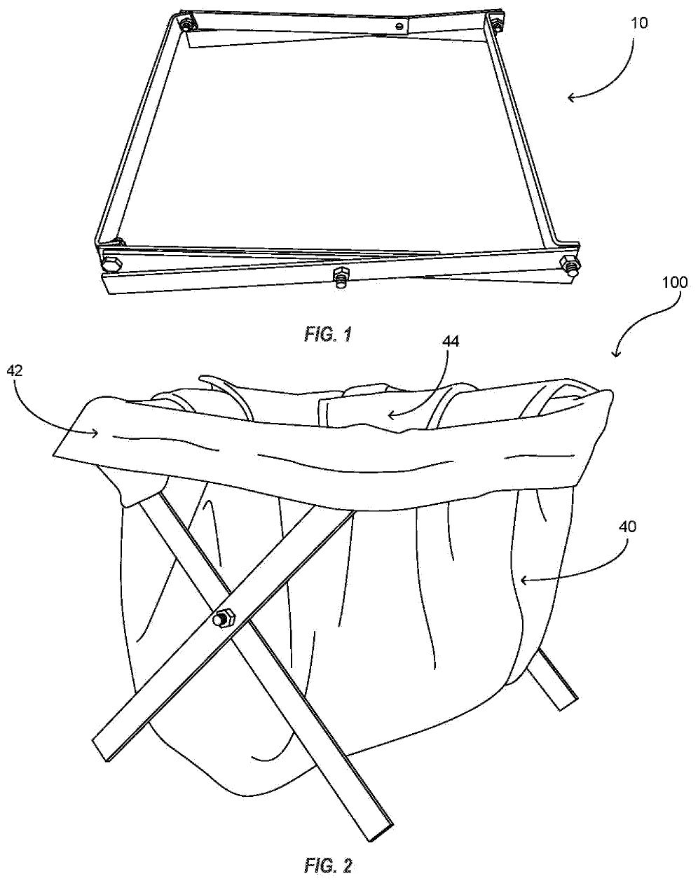

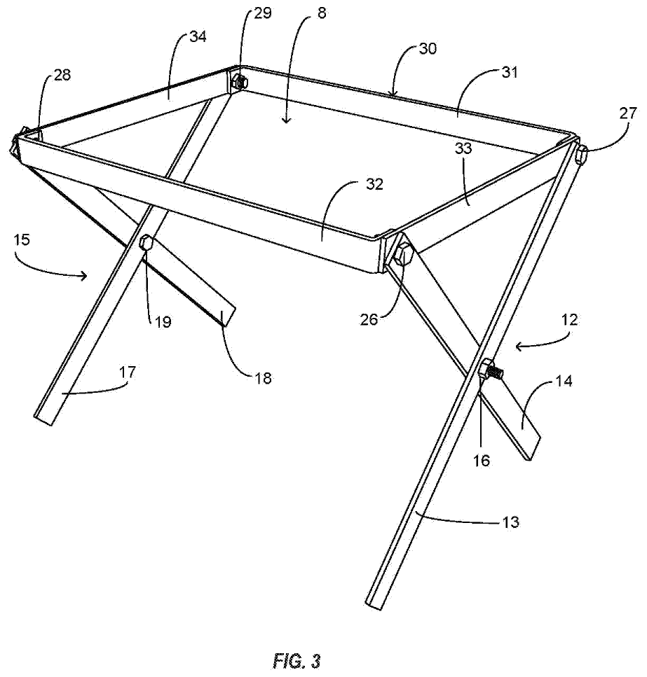

The frame 10 includes a first pair of leg members 12 and a second pair of leg members 15 that are located on opposing ends of the frame 10. The first pair of leg members 12 includes a first leg member 13 and a second leg member 14 that are movably coupled with fastener 16. The fastener 16 facilitates the ability for the first pair of leg members 12 to move between a collapsed position, illustrated herein in FIG. 1, and a deployed position, illustrated herein in FIG. 3. It should be understood within the scope of the present invention that the fastener 16 could be numerous types of mechanical fasteners that facilitate the desired operation of the first pair of leg members 12.

The second pair of leg members 15 are constructed identically as the first pair of leg members 12. The second pair of leg members 15 includes a first leg member 17 and a second leg member 18 that are operably coupled with fastener 19. The fastener 19 facilitates the ability for the second pair of leg members 15 to move between a collapsed position, illustrated herein in FIG. 1, and a deployed position, illustrated herein in FIG. 3. It is further contemplated within the scope of the present invention that the first pair of leg members 12 and second pair of leg members 15 could be provided so as to have telescoping portions so as to enable a greater height of the frame 10 in the deployed position. While the preferred embodiment of the present invention includes the configuration of the first pair of leg members 12 and second pair of leg members 15 as illustrated herein, it is contemplated within the scope of the present invention that the first pair of leg members 12 and second pair of leg members 15 could be alternately constructed and achieve the desired objective discussed herein.

The frame 10 includes top support member 30. The top support member includes opposing longitudinal support members 31,32 and opposing lateral support members 33,34 wherein the opposing longitudinal support members 31,32 and opposing lateral support members 33,34 are operably coupled to form the top support member 30. The top support member 30 forms the upper perimeter of the frame 10 and an opening 8 wherein the opening 8 is configured to receive containment member 40 therein. The first pair of leg members 12 is operably coupled to the top support member 30 employing fasteners 26,27. The second pair of leg members 15 is operably coupled to the top support member 30 employing fasteners 28,29. Fasteners 26,27 and fasteners 28,29 are configured to assist in the moving of the frame 10 between a collapsed position, illustrated herein in FIG. 1, and a deployed position, illustrated herein in FIG. 3.

The collapsible soil container 100 further includes the containment member 40. The containment member 40 is manufactured from a material such as but not limited to burlap. The containment member 40 is placed through the opening 8 of the frame 10 and has an upper portion 42 positioned to surroundably mount the top support member 30. The containment member 40 ensuing being operably coupled to the frame 10 has opening 44 wherein a user of the collapsible soil container 100 can place soil into the opening 44.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A collapsible soil container that is configured to be transitioned from a collapsed position to a deployed position in order to receive soil therein wherein the collapsible soil container comprises:
a frame, said frame having a first end and a second end, said frame having a first pair of leg members operably coupled to said first end of said frame, said frame having a second pair of leg members operably coupled to said second end of said frame, said frame having a top support member, said top support member having opposing longitudinal support members and opposing lateral support members being operably coupled to create an opening, said top support member being operably coupled to said first pair of leg members and said second pair of leg members proximate the opposing lateral support members, said top support member defining an upper perimeter for said frame; and
a containment member, said containment member configured to be journaled through said opening, said containment member having an upper portion wherein said upper portion is configured to be releasably secured to said top support member of said frame, said containment member having an interior volume, said containment member having an opening providing access to said interior volume, said interior volume of said containment member configured to receive and retain soil therein.

2. The collapsible soil container that is configured to be transitioned from a collapsed position to a deployed position in order to receive soil therein as recited in claim 1, wherein said first pair of leg members includes a first leg member and a second leg member, said first leg member and said second leg member of said first pair of leg members being operably coupled at a midpoint thereof with a fastener, said first leg member and said second leg member of said first pair of leg members being operably coupled in a crossing arrangement.

3. The collapsible soil container that is configured to be transitioned from a collapsed position to a deployed position in order to receive soil therein as recited in claim 2, wherein said containment member is manufactured from burlap.

4. The collapsible soil container that is configured to be transitioned from a collapsed position to a deployed position in order to receive soil therein as recited in claim 3, wherein said second pair of leg members includes a first leg member and a second leg member, said first leg member and said second leg member of said second pair of leg members being operably coupled at a midpoint thereof with a fastener, said first leg member and said second leg member of said second pair of leg members being operably coupled in a crossing arrangement.

5. The collapsible soil container that is configured to be transitioned from a collapsed position to a deployed position in order to receive soil therein as recited in claim 4, wherein in said collapsed position said first leg member and said second leg member of said first pair of leg members are adjacent each other approximately a full length thereof.

6. The collapsible soil container that is configured to be transitioned from a collapsed position to a deployed position in order to receive soil therein as recited in claim 5, wherein in said deployed position said first leg member and said second leg member of said first pair of leg members are arranged in a X shape.

7. The collapsible soil container that is configured to be transitioned from a collapsed position to a deployed position in order to receive soil therein as recited in claim 6, wherein in said collapsed position said first leg member and said second leg member of said second pair of leg members are adjacent each other approximately a full length thereof.

8. The collapsible soil container that is configured to be transitioned from a collapsed position to a deployed position in order to receive soil therein as recited in claim 7, wherein in said deployed position said first leg member and said second leg member of said second pair of leg members are arranged in a X shape.
